(19) United States
(12) Patent Application Publication
(10) Pub. No.: US 2025/0110806 A1
(43) Pub. Date: Apr. 3, 2025

(54) COMPOSED API REQUESTS WITH ZERO-SHOT LANGUAGE MODEL INTERFACES

(71) Applicant: Dell Products L.P., Round Rock, TX (US)

(72) Inventors: David Burth Kurka, Campinas – SP (BR); Pedro Chem, Porto Alegre (BR); Iam Palatnik de Sousa, Rio de Janeiro (BR); Vinicius Michel Gottin, Rio de Janeiro – RJ (BR); Paulo Abelha Ferreira, Rio de Janeiro – RJ (BR); Joel Christner, El Dorado Hills, CA (US)

(21) Appl. No.: 18/478,748

(22) Filed: Sep. 29, 2023

(51) Int. Cl. G06F 9/54

(52) U.S. Cl. CPC G06F 9/54

(57) ABSTRACT

One example method includes receiving a plain language request from a user, with a zero shot classification model, determining, and selecting, application program interfaces (APIs) needed to fulfill the plain language request, with a large language model (LLM), processing the APIs to generate a preliminary plan which comprises an order in which the APIs must be called in order to fulfill the plain language request, for each of the APIs in the preliminary plan, determining respective parameters, and combining the parameters with the APIs to generate a final plan which, when executed, fulfills the plain language request.

### FIELD OF THE INVENTION

Embodiments of the present invention generally relate to human-machine interaction. More particularly, at least some embodiments of the invention relate to systems, hardware, software, computer-readable media, and methods, for interpreting human instructions and translating those instructions into machine instructions that can use API calls to fulfill the human instructions.

### BACKGROUND

Typical computer applications interact through structured syntax, defined by a set of data and operation contracts that specify the Application Programming Interface (API). Although API specifications are helpful for the understanding of the public methods of an application, their main purpose is not to establish communication between humans and applications, but instead to facilitate communication between and among computing systems. Therefore, conventional approaches thus restrict the direct usage of the application to users that have some level of technical expertise, so as to be able understand the structured syntax and commands, and impose some level of domain specific knowledge of the API itself even for specialist users. Thus, methods that allow non-specialist users to directly interact with applications and lessen the burden of knowledge for specialists when dealing with a new API, are desirable.

Although there are a few products that enable the translation of commands in unstructured natural language into API calls, a common challenge is that commands need to be well formed and relate specifically to single, and predefined, API calls. For example, there are services that can map a simple natural language request such as “what is the weather in London?” to a single API call. Other requests, such as “which of the following places is warmer right now: London or New York?,” may involve multiple operations and computations, which may imply the use of multiple APIs. However, conventional approaches are unable to handle these types of requests.

### BRIEF DESCRIPTION OF THE DRAWINGS

In order to describe the manner in which at least some of the advantages and features of the invention may be obtained, a more particular description of embodiments of the invention will be rendered by reference to specific embodiments thereof which are illustrated in the appended drawings. Understanding that these drawings depict only typical embodiments of the invention and are not therefore to be considered to be limiting of its scope, embodiments of the invention will be described and explained with additional specificity and detail through the use of the accompanying drawings.

FIG. 1 discloses aspects of an example architecture and method according to an embodiment.

FIG. 2 discloses aspects of a computing entity operable to carry out any of the disclosed methods, processes, and operations.

### DETAILED DESCRIPTION OF SOME EXAMPLE EMBODIMENTS

Embodiments of the present invention generally relate to human-machine interaction. More particularly, at least some embodiments of the invention relate to systems, hardware, software, computer-readable media, and methods, for interpreting human instructions and translating those instructions into machine instructions that can use API (application program interface) calls to fulfill the human instructions. In one embodiment, the involvement of the human user is limited solely to submitting the request, and all operations performed in response to that request are computer-implemented. The human instructions may take any form that may be translated into machine instructions and, as such, example forms of human instructions include, but are not limited to, non-verbal instructions such as written instructions, spoken, that is, verbal, instructions, and combinations of such verbal and non-verbal instructions. Both verbal and non-verbal instructions may be conveyed by user interfaces (UI) such as, but not limited to, microphones, keyboards, mouse devices, pens, styluses, and any other UI that enables a human to interact with a computing device or other machine.

One example embodiment is directed to a method that comprises operations including: [1] using a zero-shot classification model, filtering which tools are relevant for the task, that is, a task requested by a human, and selecting a subset of the building block tools—this is a tools selection process; [2] using a generative LLM, give both the user request, or task, and the selected tools, and use the language model to produce a plan of action with the tools available—this is a planning process; and, [3] using an iterative process, find input parameters for the tools from: (a) user prompt and (b) output from previous tools. The input parameters may be found by using extractive question answering LLM on (a)+(b). Having all inputs specified, a tool May then be executed, such as through an API request or built-in function call, and more output is produced and concatenated to (b).

Embodiments of the invention, such as the examples disclosed herein, may be beneficial in a variety of respects. For example, and as will be apparent from the present disclosure, one or more embodiments of the invention may provide one or more advantageous and unexpected effects, in any combination, some examples of which are set forth below. It should be noted that such effects are neither intended, nor should be construed, to limit the scope of the claimed invention in any way. It should further be noted that nothing herein should be construed as constituting an essential or indispensable element of any invention or embodiment. Rather, various aspects of the disclosed embodiments may be combined in a variety of ways so as to define yet further embodiments. For example, any element(s) of any embodiment may be combined with any element(s) of any other embodiment, to define still further embodiments. Such further embodiments are considered as being within the scope of this disclosure. As well, none of the embodiments embraced within the scope of this disclosure should be construed as resolving, or being limited to the resolution of, any particular problem(s). Nor should any such embodiments be construed to implement, or be limited to implementation of, any particular technical effect(s) or solution(s). Finally, it is not required that any embodiment implement any of the advantageous and unexpected effects disclosed herein.

In particular, one advantageous aspect of an embodiment of the invention is that human users with limited technical skills may be able to obtain translations of human requested tasks into tasks that are executable by a computing system. An embodiment of the invention may enable a human user to interact with a computing system, using instructions understandable by the computing system, using a translation functionality. Various other advantages of one or more example embodiments will be apparent from this disclosure.

It is noted that embodiments of the invention, whether claimed or not, cannot be performed, practically or otherwise, in the mind of a human. Accordingly, nothing herein should be construed as teaching or suggesting that any aspect of any embodiment of the invention could or would be performed, practically or otherwise, in the mind of a human. Further, and unless explicitly indicated otherwise herein, the disclosed methods, processes, and operations, are contemplated as being implemented by computing systems that may comprise hardware and/or software. That is, such methods processes, and operations, are defined as being computer-implemented.

### A. Context for an Example Embodiment of the Invention

The following is a discussion of a context for an embodiment of the invention. This discussion is not intended to limit the scope of the invention, or the applicability of the embodiments, in any way.

### A.1 LLM Tasks

### A.1.1 Causal Language Modelling

CLM (causal language modelling), sometimes also known as auto-regressive modelling, is the task most commonly referred to as ‘text generation.’ In this approach, a model receives some text input, which it then proceeds to complete, token by token. The modeling performed by CLM has been referred to as ‘predicting the most likely next word/token,’ although that is an oversimplification. In order to use a CLM model for generalization to other tasks, however, typically a very large model, such as 175 billion parameters for example, is necessary.

### A.1.2 Extractive Question Answering

An NLP task that may be relevant to one or more of the problems disclosed herein is EQA (extractive question answering), in which a model is asked to retrieve some information from a context and must necessarily use only substrings from that context as potential answers. For instance, considering the context ‘Alice and Bob watched a movie,’ an EQA model might use any substring from that context to answer questions such as ‘Who watched the movie?,’ where the expected answer would be ‘Alice and Bob.’ An advantage, as well as a disadvantage, of EQA is that models will always reply with words from the context, which eliminates the tendency for hallucinations, which is the technical name for when a model replies with sensible grammar but completely making up an incorrect or non-factual answer. A significant disadvantage to EQA models is that, if asked a question that cannot be answered with that context, the model will still be forced to choose some substring from it as an answer. For example, given the context ‘/am coming back on the 17th,’ an EQA model asked a non-related question such as ‘What is the temperature right now?’ will likely answer ‘17’ because that is the only ‘sensible’ answer the EQA model can extract from the given context, although it is clear that the answer is wholly non-responsive and irrelevant to the question posed.

### A.1.3 Abstractive Question Answering

In contrast with EQA, AQA (abstractive question answering) involves a model that can respond to questions with its own choice of words, not necessarily extracting them directly from the source context. This can be particularly useful when asking ‘yes or no’ type questions, or more arbitrary questions, although it results in different pros/cons compared to EQA. For example, AQA has a greater likelihood, relative to EQA, of responding with hallucinations, that is, answers that are grammatically and semantically sensible, but completely unrelated or non-factual when compared to the context and question. At the same time, an AQA model may be able to answer more general, abstract questions that may require answers with terms not present in the context.

### A.1.4 Zero Shot Classification

A final NLP task which may be relevant to an embodiment of the invention is ZSC (zero shot classification). Unlike the other models discussed above, which involve generating text in some form, ZSC involves mapping a given text input to a set of classes or labels with different probabilities. The main difference with a traditional classification task is that NLP models learn the nuances of a language, and are potentially capable of classifying unseen text into previously unseen labels, by evaluating the meaning and content within the text and labels. For example, given the example context ‘Resize the picture dog.jpg to 125×125,’ a ZSC model might be asked whether this sentence represents a call to an image, text or audio related method, and the ZSC model might identify that it should call an image method.

ZSC may be based on a number of techniques, but more often than not it is based on similarity calculations between the context and label strings. One potential way to calculate this similarity is using cosine similarity between the sentence embeddings of the strings, where sentence embeddings are vectors that encode the semantic content of the strings.

### A.2 Application Programming Interface (API) Specifications

Generally speaking, APIs provide a series of methods that users or systems can call upon to interact with a machine, its services, or its data. For example, some methods or processes that may be called with respect to data include commands such as ‘create,’ ‘read,’ ‘update,’ ‘delete,’ and ‘search.’ APIs commonly follow a set of standards, or specifications such as the OpenAPI standard, where the methods, functions, inputs, outputs, constraints, and conditions within the API are annotated and described in an orderly fashion for the purpose of enabling developers to write robust integrations leveraging those APIs. An embodiment of the invention may leverage this structure, in particular the annotation fields, in order to use it as input for the LLMs in an embodiment disclosed herein.

### B. Overview of Aspects of an Example Embodiment of the Invention

### B.1 Introduction

Multiple solutions aiming to interface natural language and API communication exist in the literature. Currently however, existing approaches are carefully designed for specific scenarios and do not easily adapt to different contexts.

For example, one approach proposes to map natural language commands to web API calls by first mapping the command to a semantic representation which the API call be inferred from. Their approach is similar to the popular task of language translation in NLP, and requires training a model on a dataset specifically made for a particular kind of API. However, this limits the broad usability of the framework by imposing prior time-consuming and complex tasks, such as collecting a dataset and training a model.

Another approach proposes to leverage ChatGPT to generate code for achieving task-specific goals in a robotic environment. In contrast with an embodiment of the invention, this approach focuses on the domain of robot problems and relying on the use of a private-source language model. Additionally, full environment knowledge is required to adapt the solution to different settings.

Finally, yet another proposed approach involves Toolformer, a model which decides when to incorporate results from API calls to the model output. The main objective of this approach is to improve the communication between the user and the model, by allowing the model to have more accurate results through API calls. The framework differs significantly from an embodiment of the invention, which serves to interface human communication with API calls, and not with a model.

### B.2. Example Embodiment Overview

With the recent advent of LLMs, the understanding of natural language has greatly improved, which facilitates human-machine interaction and expands on the opportunities for leveraging natural language to different contexts. Thus, an example embodiment of the invention employs LLMs to interpret complex human instructions given in natural language, so the human instructions can be translated into a combination or sequence of machine instructions that use one or more API calls to fulfill user requests. That is, given a user query, determine API services that can be useful to generate relevant information for each portion of the query, formulate a plan of action that defines in which order API methods should be called and with which inputs, combine inputs and outputs in higher level commands, and finally discern and return the answer to the user query. Thus, an embodiment of the invention is concerned with compound API selection and tasks planning used to fulfill the request.

In more detail, given that API specifications are often disclosed with documentation, such as the OpenAPI specification for example, that contains natural language descriptions of its methods, the first operation in one example embodiment comprises parsing different API specifications and defining, for each method, the input and output descriptions and schemas. These may be considered the building blocks that will form compound operations. Additionally, in connection with the discovered API methods, it is also possible to use built-in operators which may be able to manipulate input and output in pre-established ways to produce an extended set of building blocks tools, where such manipulations may comprise, for example, ‘max,’ ‘min,’ ‘filter,’ ‘map,’ and ‘reduce.’

Further, given a user request, in natural language format, a sequence of operations may be performed, in a particular order, using underlying APIs. The result of each operation may or may not influence the next, but at the end of the sequence of API interactions, the desired output may be produced and returned to the user. In an embodiment, the following sequency of operations may be performed: [1] tools selection-select relevant building blocks that will be used to satisfy the request; [2] planning-define the dependencies and ordering in which tools are used; and [3] input and output chaining-define what are the input parameters required for each tool, and what is the relevant output that can be used either as new inputs to another tool, or as final output. In an embodiment, these operations may be executed in the indicated order, and may be enabled by open-source LLMs, thus: [1] using a zero-shot classification model, filter which tools are relevant for the task and select a subset of the building block tools—this is the tools selection process; [2] using a generative LLM, give both the user request, also referred to herein as a ‘task,’ and the selected tools, and use the language model to produce a plan of action with the tools available—this is the planning process; and, [3] using an iterative process, find input parameters for the tools from: (a) user prompt and (b) output from previous tools. The input parameters may be found by using extractive question answering LLM on (a)+ (b)—having all inputs specified, a tool may be executed, such as through an API request or built-in function call, and more output is produced and concatenated to (b).

As will be apparent from this disclosure, example embodiments of the invention may possess one or more useful features and aspects. For example, an embodiment may enable a human user to create complex user-APIs interactions from natural language, without previous technical knowledge. As another example, an embodiment may be able to answer a broader set of questions that are applicable in a human context rather than discrete systems-related question. An embodiment may operate to automatically choose multiple relevant APIs, endpoints, and methods to fulfill a user request. In another example, an embodiment may operate to create an action plan that combines different tools using LLM engines, e.g. an orchestration of underlying requests that would comprise a result to a natural language question. Further, an embodiment may operate to define, order, and then leverage a series of tools in sequence, be in sequential, parallel, or hierarchical, to facilitate answering the provided natural language question. As a final example, an embodiment may operate to leverage the result from one particular tool as an input to another tool.

### C. Detailed Discussion of an Example Embodiment of the Invention

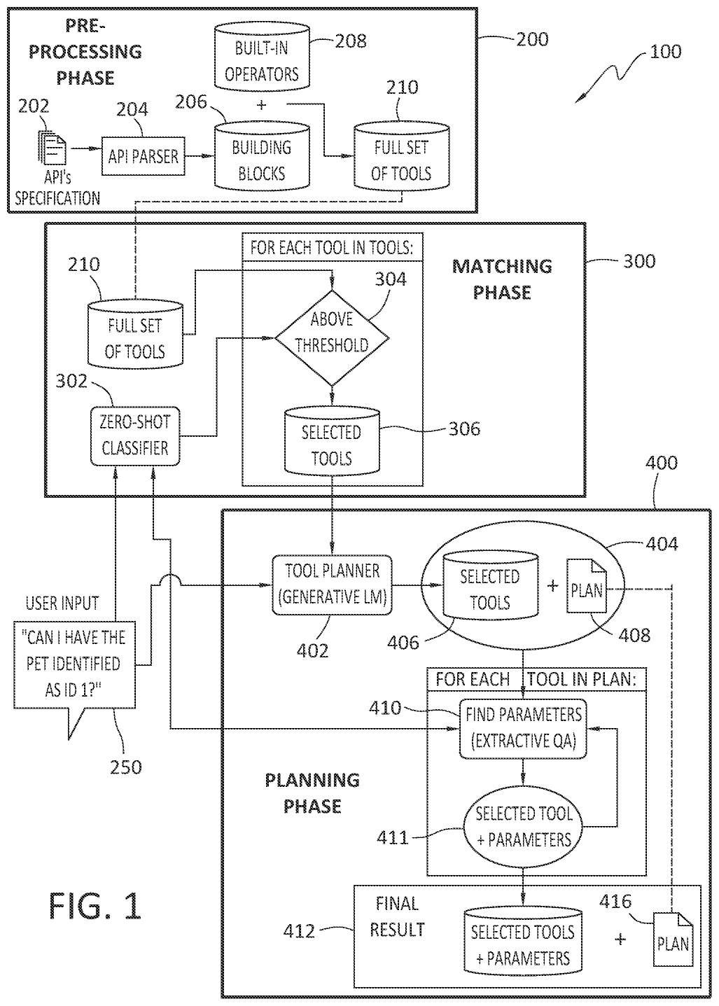

With attention now to FIG. 1, an example embodiment of the invention may comprise a framework 100. In general, this embodiment may comprise various phases, namely, a pre-processing phase 200 which collects the necessary information for further phases, a matching phase 300 responsible for selecting the API methods and built-in operators that match user requests, and a planning phase 400 that finds the correct order for combining the selected tools to produce the appropriate result. Execution of a plan that comprises or otherwise embodies the correct order may thus involve the incrementing of APIs, that is, an API of a group of identified APIs may be called after, and as a result of, the calling of another API and, in this way, the APIs in the group may be incremented until all of the APIs have been called.

In an embodiment, each of the phases 200, 300, and 400, may be implemented by a respective computing entity, examples of which are disclosed herein. In another embodiment, the phases 200, 300, and 400, may all be implemented by a single computing entity. More generally, no particular allocation of the functions, individually embraced by the phases 200, 300, and 400, among computing hardware and/or software is required.

### C.1 Pre-Processing Phase

In an embodiment, the pre-processing phase 200 may be performed independent, and in advance, of the matching phase 300 and the planning phase 400. In an embodiment, the input 202 to the pre-processing phase 200 may comprise a diverse set of APIs with respective structured documentation that contains an objective description of the methods of the APIs. The pre-processing phase 200 may begin with the parsing, by an API parser 204, of the respective documentation for each API. Particularly, for each API method, information is collected from the corresponding documentation that may be used to form what may be referred to herein as ‘building blocks’ for use in compound operations, as explained elsewhere herein. The building blocks 206 may be stored in a database. The information collected from the API documentation may include, but is not limited to, a description of the method implemented by the API, a description of the method parameters, a description of the method response, and a description of the method schema.

In addition to the building blocks, an embodiment of the invention may also make use of built-in operators such as ‘max,’ ‘min,’ ‘filter,’ ‘map,’ and ‘reduce’ which may be used to manipulate API results and produce the desired output for a user. The built-in operators 208, which may be stored in a database, may each be assigned a description of the operator, a description of the operator inputs, and a description of the operator outputs. As shown in FIG. 1, the aggregation of the building blocks with the built-in operators forms a set of tools 210 that may be stored in a database. Once the set of tools is formed, the framework 100 is ready to perform the matching phase 300.

### C.2 Matching Phase

Given a user request 250, in natural language, the framework 100 may enter the matching phase 300 to identify the API methods and built-in functions that are relevant to the user request 250. In an embodiment, this may be accomplished by using an open-source ZSC (zero-shot classification) model 302 and defining a pre-determined threshold value T. More specifically, the ZSC model 302 may, for each tool in the tool set 210, compare 304 the user request 250 with all the descriptions of the API methods and built-in operators inside the tools set. If the matching score is above the threshold T, the tool is selected 306 for use in the planning phase 400, otherwise the tool is not selected.

### C.3 Planning Phase

In an embodiment, the planning phase 400 may assume use of only the selected subset of tools that match the user request, as determined at 304. The planning phase 400 may leverage the planning ability of a generative LLM 402, which may be in the form of a large AQA model for example, to provide the generative LLM 402 with a subset of tools, and to obtain from the generative LLM 402, the order in which the tools should be combined to respond to the user input 250. A prompt may then be formed by combining the user request with the description of the selected API methods and built-in operators. The generative LLM 402 may then generate a correct order in which the selected tools should be used. Thus, an output 404 of the generative LLM 402 may comprise a combination of the selected tools 406, and a plan 408 that specifies the combination, order, and use, of the selected tools 406.

As an example, consider a user request 250 as follows: “find if the temperature is going to be higher today or in the next 3 days in Sao Paulo,” coupled with the following tools and the respective descriptions of the tools:
current_temperature( ) “finds current temperature for a city.”
forecast_temperature( ) “forecasts temperature for a city for a specific number of days.”
max: “calculates the maximum between two values.”
   Then, a prompt for the generative LLM 402 might be formed as:
“I want to find if the temperature is going to be higher today or in the next 3 days in Sao Paulo.

The tools I have are:
current_temperature( ) which finds current temperature for a city,
forecast_temperature( ) which forecasts temperature for a city for a specific number of days,
max which calculates the maximum between two values.
   In which order should the tools can be combined to accomplish the request?”

The generative LLM 402 may then provide a correct order for the tools so that when the tools are employed in that order, the request will be successfully fulfilled. Note that in an embodiment, this output of the generative LLM 402 may be only a preliminary result.

At this stage of the planning phase 400, it may still be necessary to find the correct parameter values for the tools. In order to do this, an embodiment may comprise an EQA (extractive question answerer) model 410, that may iterate over each of the selected the tools in order, performing the following operations, and each iteration may generate a pair 411 that comprises a particular selected tool, and parameters for that tool:
1. Define the user request 250 as the context variable for the EQA model 410;
2. Iterate over the tools 210 in the order provided by the generative LLM 402;
3. Ask the EQA model 410, providing the context variable, what should be the input value of the tool 210 input description (collected in the pre-processing phase 200);
4. Save the answer from the EQA model 410 and update the context variable by adding the output description of the tool 210; and
5. Repeat steps 3-4 for all selected tools 210.

The EQA model should be able to infer the correct parameters values by extracting information from the context variable. Step 4 (above) may guarantee that the EQA model 410 is able to find input values for tools 210 that depend on the output of other tools 210 by expanding the context variable. Finally, at the end of the planning phase 400, the framework 100 has all the necessary information to create API requests and manipulate their results using built-in operators, achieving the desired result of the user request. That is, the framework 100 may have a set of final results 412 that comprises a combination 414 of the selected tools and parameters for the selected tools, and a plan 416 that comprises an order in which the tools are to be employed.

### D. Example Methods

It is noted with respect to the disclosed methods, including the example method of FIG. 1, that any operation(s) of any of these methods, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

### E. Further Example Embodiments

Following are some further example embodiments of the invention. These are presented only by way of example and are not intended to limit the scope of the invention in any way.

Embodiment 1. A method, comprising: receiving a plain language request from a user; with a zero shot classification model, determining, and selecting, application program interfaces (APIs) needed to fulfill the plain language request; with a large language model (LLM), processing the APIs to generate a preliminary plan which comprises an order in which the APIs must be called in order to fulfill the plain language request; for each of the APIs in the preliminary plan, determining respective parameters; and combining the parameters with the APIs to generate a final plan which, when executed, fulfills the plain language request.

Embodiment 2. The method as recited in any preceding embodiment, wherein the plain language request cannot be fulfilled by only a single API.

Embodiment 3. The method as recited in any preceding embodiment, wherein API specifications are parsed to obtain information used to select the APIs.

Embodiment 4. The method as recited in any preceding embodiment, wherein the order of the APIs accounts for any dependencies between, or among, the APIs.

Embodiment 5. The method as recited in any preceding embodiment, wherein the parameters for one of the APIs are obtained using a user prompt, and output from another of the APIs that is upstream of that API.

Embodiment 6. The method as recited in any preceding embodiment, further comprising executing the final plan.

Embodiment 7. The method as recited in any preceding embodiment, wherein a user prompt is defined by combining the plain language request with a description of the selected APIs and any built-in operators respectively associated with the selected APIs.

Embodiment 8. The method as recited in any preceding embodiment, wherein one of the selected APIs is associated with an operator that is operable to manipulate an input to, and/or an output from, that API.

Embodiment 9. The method as recited in any preceding embodiment, wherein an output of one of the APIs serves as an input to another of the APIs.

Embodiment 10. The method as recited in any preceding embodiment, wherein the order in which the APIs are arranged comprises any one or more of a sequential order, a parallel order, and a hierarchical order.

Embodiment 11. A system, comprising hardware and/or software, operable to perform any of the operations, methods, or processes, or any portion of any of these, disclosed herein.

Embodiment 12. A non-transitory storage medium having stored therein instructions that are executable by one or more hardware processors to perform operations comprising the operations of any one or more of embodiments 1-10.

### F. Example Computing Devices and Associated Media

The embodiments disclosed herein may include the use of a special purpose or general-purpose computer including various computer hardware or software modules, as discussed in greater detail below. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that execute on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to carry out executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

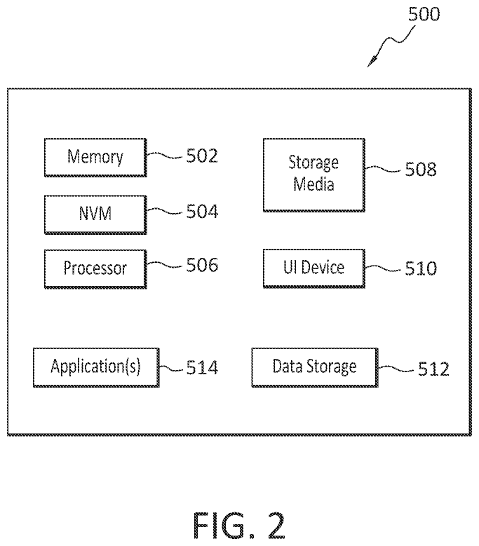

With reference briefly now to FIG. 2, any one or more of the entities disclosed, or implied, by FIG. 1, and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 2.

In the example of FIG. 2, the physical computing device 500 includes a memory 502 which may include one, some, or all, of random access memory (RAM), non-volatile memory (NVM) 504 such as NVRAM for example, read-only memory (ROM), and persistent memory, one or more hardware processors 506, non-transitory storage media 508, UI device 510, and data storage 512. One or more of the memory components 502 of the physical computing device 500 may take the form of solid state device (SSD) storage. As well, one or more applications 514 may be provided that comprise instructions executable by one or more hardware processors 506 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method, comprising:
receiving a plain language request from a user;
with a zero shot classification model, determining, and selecting, application program interfaces (APIs) needed to fulfill the plain language request;
with a large language model (LLM), processing the APIs to generate a preliminary plan which comprises an order in which the APIs must be called in order to fulfill the plain language request;
for each of the APIs in the preliminary plan, determining respective parameters; and
combining the parameters with the APIs to generate a final plan which, when executed, fulfills the plain language request.

2. The method as recited in claim 1, wherein the plain language request cannot be fulfilled by only a single API.

3. The method as recited in claim 1, wherein API specifications are parsed to obtain information used to select the APIs.

4. The method as recited in claim 1, wherein the order of the APIs accounts for any dependencies between, or among, the APIs.

5. The method as recited in claim 1, wherein the parameters for one of the APIs are obtained using a user prompt, and output from another of the APIs that is upstream of that API.

6. The method as recited in claim 1, further comprising executing the final plan.

7. The method as recited in claim 1, wherein a user prompt is defined by combining the plain language request with a description of the selected APIs and any built-in operators respectively associated with the selected APIs.

8. The method as recited in claim 1, wherein one of the selected APIs is associated with an operator that is operable to manipulate an input to, and/or an output from, that API.

9. The method as recited in claim 1, wherein an output of one of the APIs serves as an input to another of the APIs.

10. The method as recited in claim 1, wherein the order in which the APIs are arranged comprises any one or more of a sequential order, a parallel order, and a hierarchical order.

11. A non-transitory storage medium having stored therein instructions that are executable by one or more hardware processors to perform operations comprising:
receiving a plain language request from a user;
with a zero shot classification model, determining, and selecting, application program interfaces (APIs) needed to fulfill the plain language request;
with a large language model (LLM), processing the APIs to generate a preliminary plan which comprises an order in which the APIs must be called in order to fulfill the plain language request;
for each of the APIs in the preliminary plan, determining respective parameters; and
combining the parameters with the APIs to generate a final plan which, when executed, fulfills the plain language request.

12. The non-transitory storage medium as recited in claim 11, wherein the plain language request cannot be fulfilled by only a single API.

13. The non-transitory storage medium as recited in claim 11, wherein API specifications are parsed to obtain information used to select the APIs.

14. The non-transitory storage medium as recited in claim 11, wherein the order of the APIs accounts for any dependencies between, or among, the APIs.

15. The non-transitory storage medium as recited in claim 11, wherein the parameters for one of the APIs are obtained using a user prompt, and output from another of the APIs that is upstream of that API.

16. The non-transitory storage medium as recited in claim 11, further comprising executing the final plan.

17. The non-transitory storage medium as recited in claim 11, wherein a user prompt is defined by combining the plain language request with a description of the selected APIs and any built-in operators respectively associated with the selected APIs.

18. The non-transitory storage medium as recited in claim 11, wherein one of the selected APIs is associated with an operator that is operable to manipulate an input to, and/or an output from, that API.

19. The non-transitory storage medium as recited in claim 11, wherein an output of one of the APIs serves as an input to another of the APIs.

20. The non-transitory storage medium as recited in claim 11, wherein the order in which the APIs are arranged comprises any one or more of a sequential order, a parallel order, and a hierarchical order.
